(19) United States
(12) Patent Application Publication
(10) Pub. No.: US 2009/0115084 A1
(43) Pub. Date: May 7, 2009

(54) Slip-casting method of fabricating zirconia blanks for milling into dental appliances

(75) Inventor: Haksung Moon, Irvine, CA (US)

Correspondence Address: LEONARD TACHNER, A PROFESSIONAL LAW;CORPORATION, 17961 SKY PARK CIRCLE, SUITE 38-E, IRVINE, CA, 92614, US

(73) Assignee: James R. Glidewell Dental Ceramics, Inc.

(21) Appl. No.: 12/290,089

(22) Filed: Oct. 27, 2008

Related U.S. Application Data
(60) Provisional application No. 61/001,953, filed on Nov. 5, 2007.

(51) Int. Cl. A61C 13/20

(52) U.S. Cl. 264/16

(57) ABSTRACT

A process for fabricating pre-sintered zirconia blanks that are then computer machined and sintered to form dental appliances having highly advantageous features. The principal steps of a preferred embodiment of that process comprise a) preparing a ceramic slurry of binderless zirconia powder; b) subjecting the slurry to attrition milling; c) preparing a vacuum assisted slip casting mold and pouring the milled slurry into the slip-casting mold; d) after casting, excess slurry is poured from the mold and a consolidated zirconia blank is removed; e) drying the blank and pre-sintering it to form solid blanks ready for CAD/CAM machining and sintering to net shape.

### CROSS-REFERENCE TO RELATED APPLICATIONS

This application takes priority from application Ser. No. 61/001,953 filed on Nov. 5, 2007.

### BACKGROUND OF THE INVENTION

1. Field of the Invention

The present invention relates generally to the manufacture of ceramic dental appliances such as crowns and bridges. The invention herein is related more particularly to the milling of zirconia blanks into such appliances where the blanks are fabricated by a vacuum assisted slip-casting method to achieve superior physical properties.

2. Background Art

Dental prosthetic devices or appliances must satisfy a number of different criteria. They need to have excellent physical properties to resist wear and mechanical deformation for very long periods of time. They should also provide good aesthetic characteristics which means that they have a natural appearance in color, texture and shape so that they are not readily distinguishable from the original natural teeth. They should also be readily fabricated at reasonable cost which means that the cost of materials used and the time required in their manufacture, be within reasonable limits.

Dental appliances made of zirconia can meet these criteria. It is a ceramic material which can be made to be extremely hard and fracture resistant. Applicant has discovered that if provided in pre-fabricated pre-sintered blanks, they can be readily machined in CAD/CAM systems and then sintered with highly predictable shrinkage to conform to virtually any desired dental appliance shape with high yield and minimal manual intervention. A key aspect of the aesthetic appearance of zirconia dental appliances would be achieved if it were possible to provide such prosthetic devices with a substantial degree of light transmissivity. Translucent appliances would exhibit the color of the underlying natural dental material and thus go a long way toward achieving a highly desirable appearance, i.e., that is matched to the color of adjacent natural teeth. Thus, if it were possible to provide pre-fabricated, pre-sintered zirconia blanks and yet still retain the advantageous mechanical and easy fabrication properties of the ceramic, that would be a significant accomplishment in the art of dental appliances. Even though Applicant is not the first to consider slip-casting zirconia for the dental appliance art (see U.S. Pat. No. 4,772,436 to Tyszblat or U.S. Pat. No. 5,975,905 to Kim et al), there is no known relevant prior art which discloses all of the process steps of the present invention for fabricating a pre-sintered zirconia blank for the dental appliance arts. Moreover, Tyszblat teaches the interlacing of fitted metal oxide particles in the solid phase and glass. Kim et al discloses the creation of a ceramic sheet of thickness 0.1 mm to 1.0 mm and then coating the sheet onto a gypsum mold under heat and pressure and then, after sintering, coating the resultant body with glass powder.

### SUMMARY OF THE INVENTION

The present invention comprises a process for fabricating pre-sintered zirconia blanks that are then computer machined and sintered to form translucent dental appliances having highly advantageous features. The principal steps of a preferred embodiment of that process comprise a) preparing a ceramic slurry of binderless zirconia powder; b) subjecting the slurry to attrition milling; c) preparing a vacuum assisted slip casting mold and pouring the milled slurry into the slip-casting mold; d) after casting, excess slurry is poured from the mold and a consolidated zirconia blank is removed; e) drying the blank and pre-sintering it to form solid blanks ready for CAD/CAM machining and sintering to net shape. In the preferred embodiment of the process herein, the zirconia powder is dispersed in deionized water using a dispersant chemical solution such as tetramethyl ammonium hydroxide to adjust the pH of the slurry and thus homogeneously disperse the zirconia powder. Other dispersants such as polyisobutylene, various acid salts and certain oils, may also serve as dispersant chemicals.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 shows the slurry preparation process by mixing zirconia powder and chemicals (either a dispersant or a chemical that controls PH) into deionized water;

FIG. 2 represents the attrition milling step;

FIG. 3 represents the vacuum slip casting step of the invention;

FIG. 4 shows the drying step of the invention;

FIG. 5 shows the pre-sintering step of the inventive process hereof; and

FIG. 6 represents the completed pre-sintered zirconia blank ready to be machined in a CAD/CAM system;

FIGS. 7 to 10 illustrate in some added detail, the slip-casting step of FIG. 3;

FIGS. 11A and 11B show an optional added slip casting step using a polymer sleeve enclosed plaster of paris mold to protect the delicate plaster of paris material during handling.

### DETAILED DESCRIPTION OF A PREFERRED EMBODIMENT

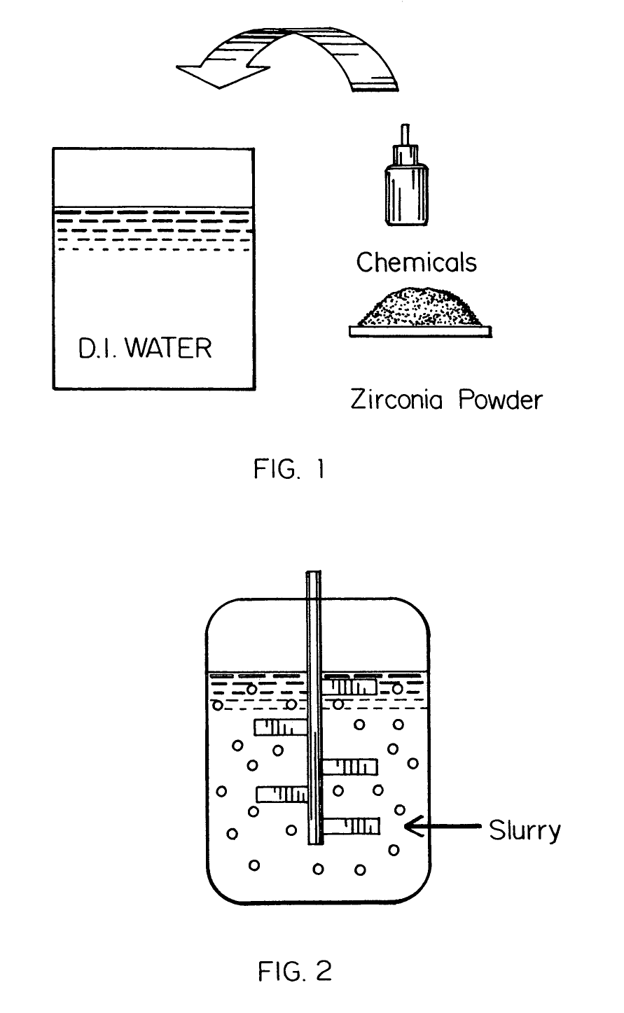

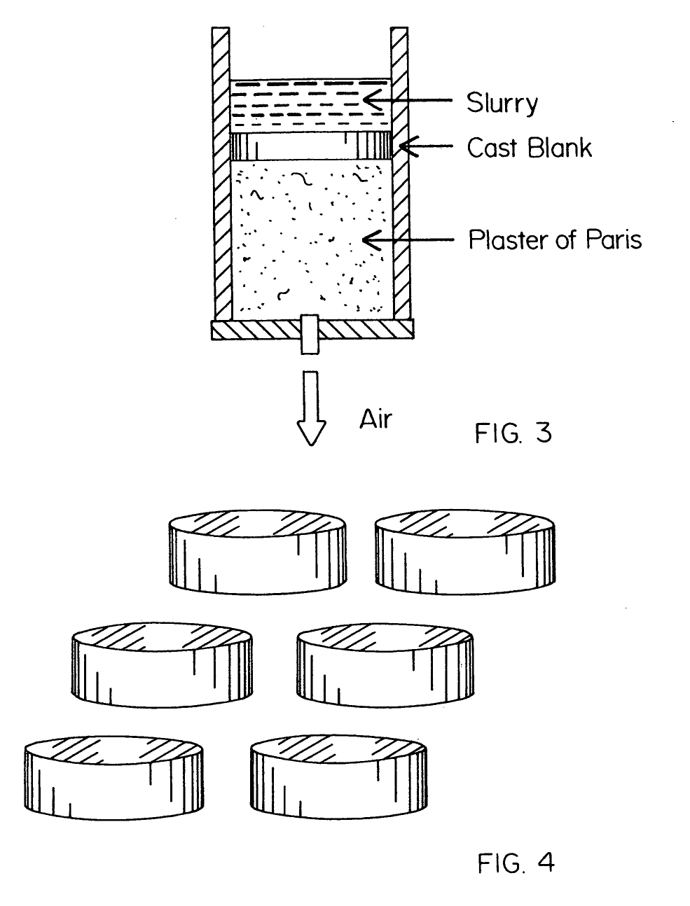

Referring to the accompanying drawings and initially to FIGS. 1 to 6, it will be seen that the present invention is a process comprising the following steps:

a) The zirconia powder is dispersed into de-ionized water using either polymer dispersants or by controlling pH with base/acid. The slurry is preferably ultra-sonicated to remove soft agglomerates and for better mixing (see FIG. 1).

b) Attrition milling the prepared slurry, preferably in a zirconia bowl (see FIG. 2).

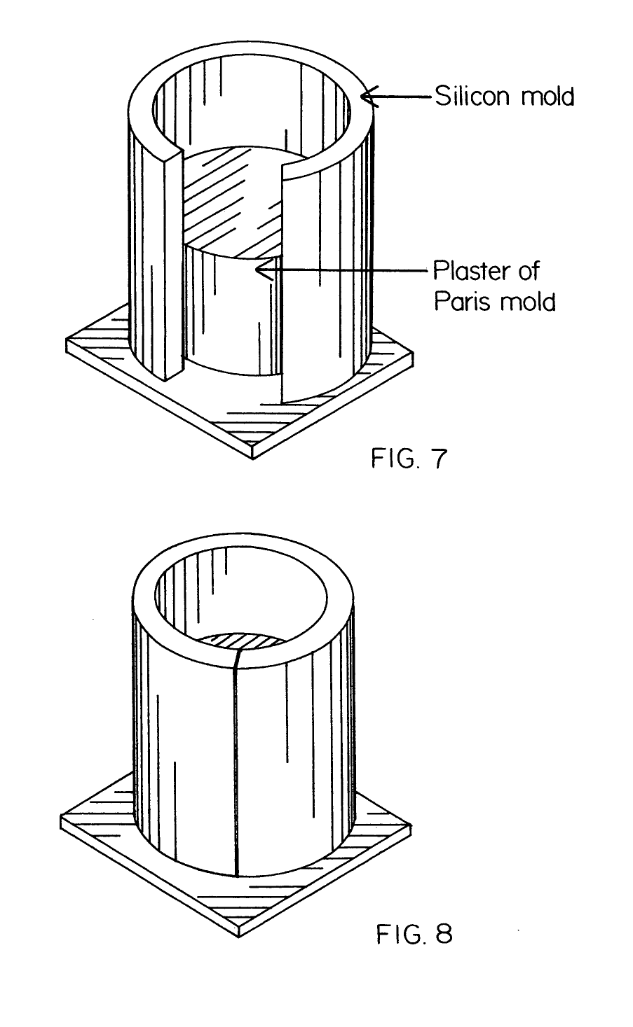

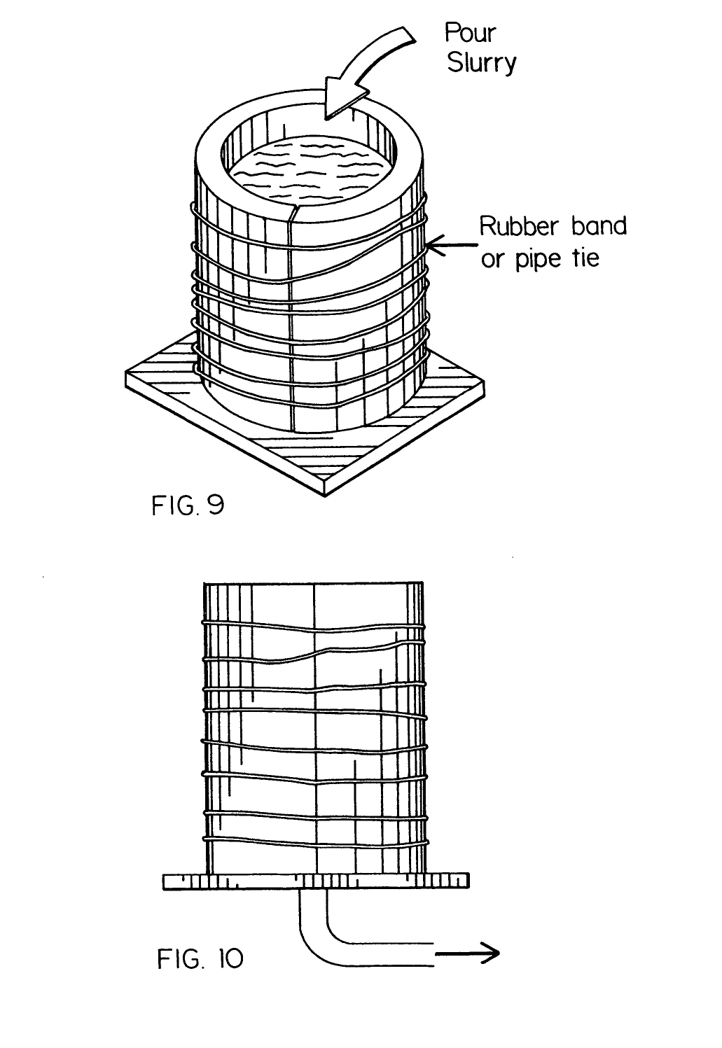

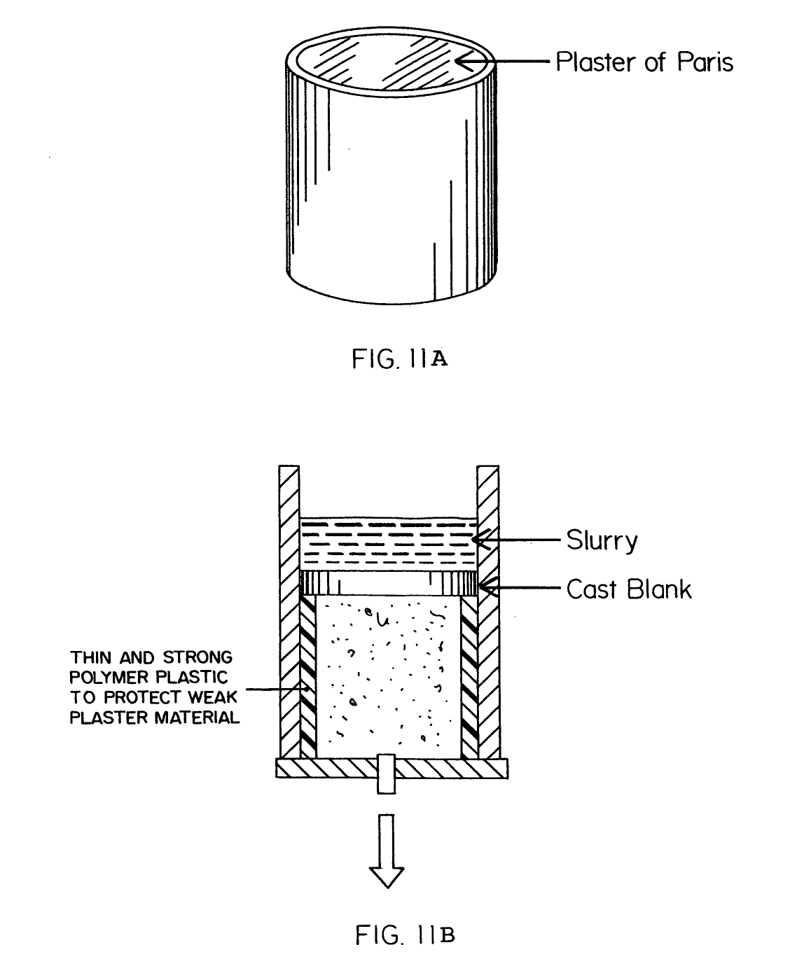

c) Slip-casting the milled slurry by preparing a porous plaster of paris mold. Placing the plaster of paris mold within a surrounding silicone mold enclosure (or enclosure of a rubber or other elastic polymer material, see FIGS. 11A and 11B) and softly tightening the enclosure around the plaster of paris to form a leak-proof system (see FIGS. 7 and 8). In the preferred embodiment, the enclosure is secured by rubber bands or pipe ties (see FIG. 9). Attaching to a bottom surface aperture of the enclosure, a vacuum line to suck out excess liquid (i.e., water) (see FIG. 10). Pouring the slurry into the enclosure above the plaster of paris mold. Eventually a slip-cast zirconia blank will form above the plaster of paris mold. This blank is removed by pouring out the excess slurry and opening the silicone mold to permit removal of the plaster of paris mold and zirconia blank.

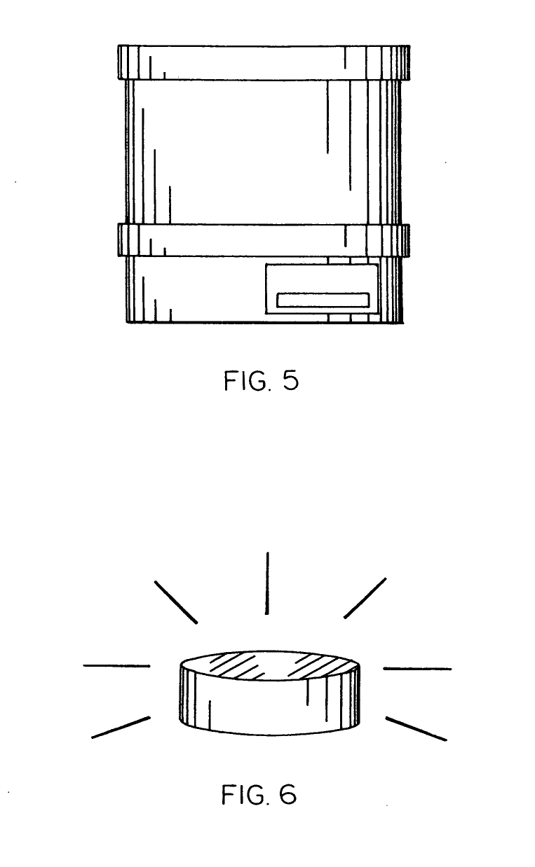

d) Each removed zirconia blank is allowed to dry at room temperature preferably using gently circulating air at low humidity (see FIG. 4). The zirconia blocks are then pre-sintered at 850° C. to 1200° C. for about two hours (see FIG. 5). The fully dried zirconia blanks are ready for computer-controlled milling and sintering to net shape (see FIG. 6).

As shown in FIGS. 11A and 11B, the plaster of paris mold may be protected from handling damage by enclosing its radial surface in a plastic or polymer sleeve.

It will now be understood that the present invention comprises a process for preparing zirconia blanks for milling into dental appliance shapes using CAD/CAM control and then sintering the shaped zirconia appliances to net shape.

Although a preferred embodiment has been disclosed herein, it will now be apparent that various modifications may be made to the various steps hereof without deviating from the principal inventive features hereof. Accordingly, the scope of the invention is to be limited only by the appended claims and to their equivalents.

I claim:

1. A process for fabricating dental appliances of translucent zirconia; the process comprising the steps of:
a) preparing a slurry of binderless zirconia powder;
b) attrition milling the slurry;
c) slip casting the milled slurry in a vacuum assisted mold;
d) removing zirconia blanks formed in said slip casting step;
e) allowing the blanks to dry;
f) pre-sintering the dried blanks;
g) shaping the fully dried, pre-sintered blanks into a desired appliance form; and
h) sintering the appliance-shaped blanks to net shape and size.

2. The process recited in claim 1 wherein step c) is performed in an openable silicone mold secured in surrounding engagement with a plaster of paris mold and attached to a vacuum.

3. The process recited in claim 1 wherein step c) is performed wherein a polymer sleeve is in radial surrounding engagement with a plaster of paris mold.

4. The process recited in claim 1 wherein step a) is performed by dispersing the zirconia powder in deionized water.

5. The process recited in claim 1 wherein step a) is performed by dispersing the zirconia powder in water.

6. The process recited in claim 1 wherein step a) is performed by dispersing the zirconia powder in water by controlled pH.

7. The process recited in claim 1 wherein step a) comprises the additional step of ultra-sonicating the slurry to remove soft agglomerates for improved mixing of the powder.

8. The process recited in claim 1 wherein step b) is performed using a zirconia bowl.

9. The process recited in claim 1 wherein step f) is performed at a temperature in the range of about 850° C. to 1200° C.

10. The process recited in claim 1 wherein step f) is performed at a temperature in the range of about 850° C. to 1200° C. for about two hours.

11. A process for forming millable blanks of zirconia for use in fabricating dental appliances; the process comprising the steps of:
a) preparing a slurry of zirconia powder dispersed by chemical dispersants in deionized water;
b) mixing the slurry to form a homogeneous slurry;
c) pouring the mixed slurry into a vacuum-assisted slip casting assembly;
d) allowing zirconia blanks to form in said assembly and removing said blanks therefrom; and
e) subjecting said zirconia blanks to a presintering temperature to achieve partial densification of said blanks.

12. The process recited in claim 11 wherein step c) is performed in an openable silicone mold secured in surrounding engagement with a plaster of paris mold and attached to a vacuum.

13. The process recited in claim 11 wherein step c) is performed wherein a polymer sleeve is in radial surrounding engagement with a plaster of paris mold.

14. The process recited in claim 11 wherein step a) is performed by dispersing the zirconia powder in water by controlled pH.

15. The process recited in claim 11 wherein step a) comprises the additional step of ultra-sonicating the slurry to remove soft agglomerates for improved mixing of the powder.

16. The process recited in claim 11 wherein step b) is performed using a zirconia bowl.

17. The process recited in claim 11 wherein step f) is performed at a temperature in the range of about 850° C. to 1200° C.

18. The process recited in claim 11 wherein step e) is performed at a temperature in the range of about 850° C. to 1200° C. for about two hours.

19. The process in claim 11 wherein said chemical dispersants in step a) comprise tetramethyl ammonium hydroxide.
